(19) United States
(12) Patent Application Publication
(10) Pub. No.: US 2016/0379151 A1
(43) Pub. Date: Dec. 29, 2016

(54) SYSTEM AND METHOD TO PROVIDE NOTIFICATIONS TO RESOURCES

(71) Applicant: Avaya Inc., Santa Clara, CA (US)

(72) Inventors: William Meaney, Co Galway (IE); Dara Geary, Co Galway (IE); Adrian Ryan, Co Galway (IE); Edel Kelly, Co Galway (IE)

(21) Appl. No.: 14/752,854

(22) Filed: Jun. 27, 2015

(51) Int. Cl. G06Q 10/06; G06Q 30/00

(52) U.S. Cl. CPC G06Q 10/06398; G06Q 30/016

(57) ABSTRACT

A computing system to manage one or more communication sessions is disclosed. The computing system includes an input module to receive at least one subscription request from at least one resource, wherein the at least one subscription request comprises a subscription criteria. The system further includes a monitoring module to monitor the one or more communication sessions to generate one or more data metrics based on the subscription criteria. The system further includes a report generation module to analyze the one or more generated data metrics to generate one or more subscription reports. The system further includes a notification module to generate one or more notifications based on the one or more generated subscription reports.

### BACKGROUND

Field

Embodiments of the present invention generally relate to a system and method to manage communication sessions in an enterprise and particularly to a system and method too provide notifications to resources to manage communication sessions in an enterprise.

Description of Related Art

Many enterprises employ contact centers to service inbound and outbound contacts or customers. A primary objective of contact center management is ultimately to maximize contact center performance and profitability. An ongoing challenge in contact center administration is monitoring and optimizing contact center efficiency usage of its available resources. The contact center efficiency generally is measured by metrics such as Service Level Agreement (‘SLA’), Customer Satisfaction (‘CSAT’), and match rate. Contact center resources may include agents, communication assets (e.g., number of voice trunks, number and bandwidth of video trunks, etc.), computing resources (e.g., a speed, a queue length, a storage space, etc.), and so forth.

Service level is one measurement of the contact center efficiency. Service level is typically determined by dividing the number of contacts accepted within a specified period by the number accepted plus number that were not accepted, but completed in some other way (e.g., abandoned, busy signal, canceled, etc.). Service level definitions may vary from one enterprise to another.

Match rate is another indicator used in measuring the contact center efficiency. Match rate is usually determined by dividing the number of contacts accepted by a primary skill level agent within a period of time by the number of contacts accepted by any agent in a queue over the same period. An agent with a primary skill level is one who typically may handle contacts of a certain nature more effectively and/or efficiently as compared to an agent of lesser skill level. There are other contact center agents who may not be as proficient as the primary skill level agent, and those agents are identified either as skill level agents or backup skill level agents. As can be appreciated, contacts received by a primary skill level agent are typically handled more quickly and accurately or effectively (e.g., higher revenue attained) than a contact received by a secondary or even backup skill level agent. Thus, it is an objective of most contact centers to optimize match rate along with the service level.

In addition to service level and match rate performance measures, contact centers use other Key Performance Indicators (‘KPIs’), such as revenue, estimated, actual, or predicted wait time, average speed of answer, throughput, resource utilization, resource performance, resource responsiveness and the like, to calculate performance relative to their Service Level Agreements (‘SLAB’). Operational efficiency is achieved when the KPIs are managed near, but not above, SLA threshold levels.

Throughput is a measure of the number of contacts/contact requests or communication sessions that may be processed in a given amount of time. Resource utilization is a measure of how efficiently the resources' time is being used. Customer service level is a measure of the time customers spend waiting for their work to be handled. Company contact center customers wish to provide service to as many requests as possible in a given amount of time, using the least number of resources to do so, and minimizing the wait time for their customers that may increase the Service Level Agreement (‘SLA’) of the contact center. Further, the contact center may also have to maintain the Customer Satisfaction (‘CSAT’) metrics in order to maintain the KPIs of the contact center. For this purpose, the resources have to provide best quality services to the customers of the contact center. Generally, to maintain the best quality of service, the resources provide services to customers based their skills and/or expertise. For example, a customer facing an issue in making audio calls from a mobile phone can be serviced by a resource skilled in repairing mobile phones. Further, if the customer is facing the issue again, then the customer may desire to communicate with the same resource to solve the issue.

Similarly, a resource of the contact center can also have special interest in specific customers, such as, high priority customers, that can increase revenue of the contact center by utilizing services. For example, an electronics distributor, who sells a wide range of electronics products, is a high priority customer of the contact center, which communicates with resources of sales and support team of the contact center. Therefore, higher customer satisfaction metrics have to be maintained for those customers, which may require regular monitoring of communication sessions to ensure continuing partnership with the electronics distributor. Further, if a resource of the contact center sales and support team is not available for a period of time (for example, on a vacation) and desires to receive information about activities of specific customers when the resource gets back to work. The resource need to gather and collect the information from multiple sources. Conventionally, the resource runs through a series of reports and sifts through customer history, recordings, notes, email threads, etc., or may rely on other resources to collect the information when they return to the contact center. The resource periodically communicates with another resource and review customer communication with a resource of the contact center to receive the information. However, conventional techniques consume a lot of time of the resources. A resource can waste time in analyzing customer history or reviewing reports and then find out that there has not been any activity of interest to the resource.

There is thus a need for a system and method to manage selection of resources to provide notifications to resources to manage communication sessions in an enterprise in a more efficient manner.

### SUMMARY

Embodiments in accordance with the present invention provide a computing system to manage one or more communication sessions in an enterprise. The computing system includes an input module to receive at least one subscription request from at least one resource, wherein the at least one subscription request comprises a subscription criteria. The system further includes a monitoring module to monitor the one or more communication sessions to generate one or more data metrics based on the subscription criteria. The system further includes a report generation module to analyze the one or more generated data metrics to generate one or more subscription reports. The system further includes a notification module to generate one or more notifications based on the one or more generated subscription reports.

Embodiments in accordance with the present invention further provide a computer-implemented method to manage one or more communication sessions in an enterprise. The method includes receiving at least one subscription request from at least one resource, wherein the at least one subscription request comprises a subscription criteria; monitoring the one or more communication sessions to generate one or more data metrics based on the subscription criteria; analyzing the one or more generated data metrics to generate one or more subscription reports; and generating one or more notifications based on the one or more generated subscription reports.

Embodiments in accordance with the present invention further provide a computer-implemented method to manage one or more communication sessions in an enterprise. The method includes receiving at least one subscription request from at least one resource, wherein the at least one subscription request comprises a subscription criteria; storing the one or more subscription criteria in at least one subscribed database; monitoring the one or more communication sessions to generate one or more data metrics based on the subscription criteria; storing the one or more data metrics in at least one customer database; analyzing the one or more generated data metrics to generate one or more subscription reports; and generating one or more notifications based on the one or more generated subscription reports.

Embodiments of the present invention may provide a number of advantages depending on its particular configuration. First, embodiments of the present application provide a system and a method to provide notifications to resources to manage communication sessions. Next, embodiments of the present application provides summary of activities of the contact center. Further, based on the summary, a resource such as a supervisor may take necessary actions. A resources may decide which customer's activities they desire to receive. Next, embodiments of the present application may proactively notifies resources about the customer's activities and eliminate the need to review reports and dig out information.

These and other advantages will be apparent from the present application of the embodiments described herein.

The preceding is a simplified summary to provide an understanding of some embodiments of the present invention. This summary is neither an extensive nor exhaustive overview of the present invention and its various embodiments. The summary presents selected concepts of the embodiments of the present invention in a simplified form as an introduction to the more detailed description presented below. As will be appreciated, other embodiments of the present invention are possible utilizing, alone or in combination, one or more of the features set forth above or described in detail below.

### BRIEF DESCRIPTION OF THE DRAWINGS

The above and still further features and advantages of embodiments of the present invention will become apparent upon consideration of the following detailed description of embodiments thereof, especially when taken in conjunction with the accompanying drawings, and wherein:

FIG. 1A illustrates a block diagram depicting a contact center, according to an embodiment of the present invention;

FIG. 1B illustrates a high level hardware abstraction of a block diagram of a server, according to an embodiment of the present invention;

FIG. 2 illustrates a functional block diagram of the server that may be used in the contact center, according to an embodiment of the present invention;

FIG. 3 depicts a flowchart of a method to manage communication sessions, according to an embodiment of the present invention; and

FIGS. 4A and 4B depict a flowchart of a method to manage communication sessions, according to another embodiment of the present invention.

The headings used herein are for organizational purposes only and are not meant to be used to limit the scope of the description or the claims. As used throughout this application, the word “may” is used in a permissive sense (i.e., meaning having the potential to), rather than the mandatory sense (i.e., meaning must). Similarly, the words “include”, “including”, and “includes” mean including but not limited to. To facilitate understanding, like reference numerals have been used, where possible, to designate like elements common to the figures. Optional portions of the figures may be illustrated using dashed or dotted lines, unless the context of usage indicates otherwise.

### DETAILED DESCRIPTION

Embodiments of the present invention will be illustrated below in conjunction with an exemplary communication system, e.g., the Avaya Aura® system. Although well suited to use with, e.g., a system having an Automatic Call Distribution (ACD) or other similar contact processing switch, embodiments of the present invention are not limited to any particular type of communication system switch or configuration of system elements. Those skilled in the art will recognize the disclosed techniques may be used in any communication application in which it is desirable to provide improved contact processing.

The phrases “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

The term “a” or “an” entity refers to one or more of that entity. As such, the terms “a” (or “an”), “one or more” and “at least one” can be used interchangeably herein. It is also to be noted that the terms “comprising”, “including”, and “having” can be used interchangeably.

The term “automatic” and variations thereof, as used herein, refers to any process or operation done without material human input when the process or operation is performed. However, a process or operation can be automatic, even though performance of the process or operation uses material or immaterial human input, if the input is received before performance of the process or operation. Human input is deemed to be material if such input influences how the process or operation will be performed.

The term “computer-readable medium” as used herein refers to any tangible storage and/or transmission medium that participate in providing instructions to a processor to execute. Such a medium may take many forms, including but not limited to, non-volatile media, volatile media, and transmission media. Non-volatile media includes, for example, NVRAM, or magnetic or optical disks. Volatile media includes dynamic memory, such as main memory. Common forms of computer-readable media include, for example, a floppy disk, a flexible disk, hard disk, magnetic tape, or any other magnetic medium, magneto-optical medium, a CD-ROM, any other optical medium, punch cards, paper tape, any other physical medium with patterns of holes, a RAM, a PROM, and EPROM, a FLASH-EPROM, a solid state medium like a memory card, any other memory chip or cartridge, a carrier wave as described hereinafter, or any other medium from which a computer can read.

The terms “customer” and “contact” may be used interchangeably in certain context of this disclosure of the present invention when referring to one or more persons/entity contacting a contact center, usually to reach an IVR system and/or one or more agents for assistance. In another context contemplated by the present invention, a “customer” may have more than one contact with the contact center at, or nearly at, the same time. For example, a customer may communicate with a contact center by way of telephone and by way of a chat, thus counting as one customer but two contacts.

In certain contexts herein, the term “resource” may include, or may be used interchangeably with, the term “agent” when referring to one or more persons/entity servicing a contact in a contact center or to a knowledge resource within an enterprise servicing back office transactions. A resource also may be known as an “interested party” if the resource is someone directly related to the contact center, e.g., an agent, a supervisor, a Subject Matter Expert (SME), etc. The interested party or resource also may be another person in the organization who is not directly related with the contact center, e.g., a Sales manager who has an interest in a high-profile account. In this case, the subscription service may be used as an early warning to potential issues. In an embodiment of the present invention, the resource may be, but is not restricted to, an agent, an available agent, a reserve agent, a trainee agent, an SME, a supervisor, and so forth.

A digital file attachment to e-mail or other self-contained information archive or set of archives is considered a distribution medium equivalent to a tangible storage medium. When the computer-readable media is configured as a database, it is to be understood that the database may be any type of database, such as relational, hierarchical, object-oriented, and/or the like. Accordingly, embodiments may include a tangible storage medium or distribution medium and prior art-recognized equivalents and successor media, in which the software embodiments of the present invention are stored.

The terms “determine”, “calculate” and “compute,” and variations thereof, as used herein, are used interchangeably and include any type of methodology, process, mathematical operation or technique.

The term “module” as used herein refers to any known or later developed hardware, software, firmware, artificial intelligence, fuzzy logic, or combination of hardware and software that is capable of performing the functionality associated with that element. Also, while the present invention is described in terms of exemplary embodiments, it should be appreciated those individual aspects of the present invention can be separately claimed.

A module that performs a function also may be referred to as being configured to perform the function, e.g., a data module that receives data also may be described as being configured to receive data. Configuration to perform a function may include, for example: providing and executing computer code that performs the function; providing provisionable configuration parameters that control, limit, enable or disable capabilities of the module (e.g., setting a flag, setting permissions, setting threshold levels used at decision points, etc.); providing a physical connection, such as a jumper to select an option, or to enable/disable an option; attaching a physical communication link; enabling a wireless communication link; energizing a circuit that performs the function (e.g., providing power to a transceiver circuit in order to receive data); and so forth.

The term “switch” or “server” as used herein should be understood to include a Private Branch Exchange (PBX), an ACD, an enterprise switch, or other type of communications system switch or server, as well as other types of processor-based communication control devices such as media servers, computers, adjuncts, etc.

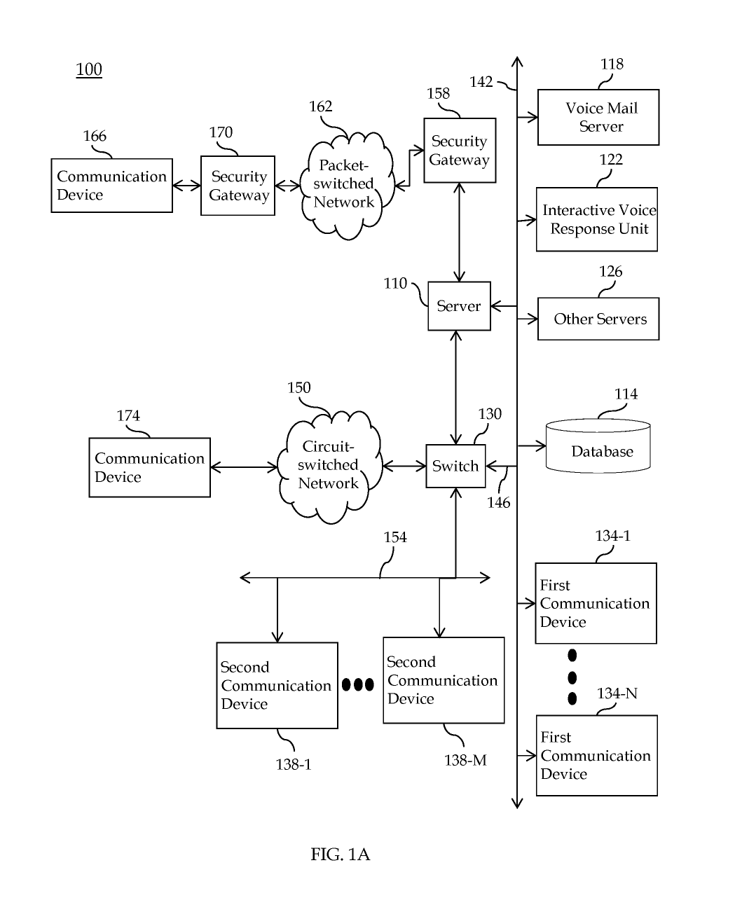

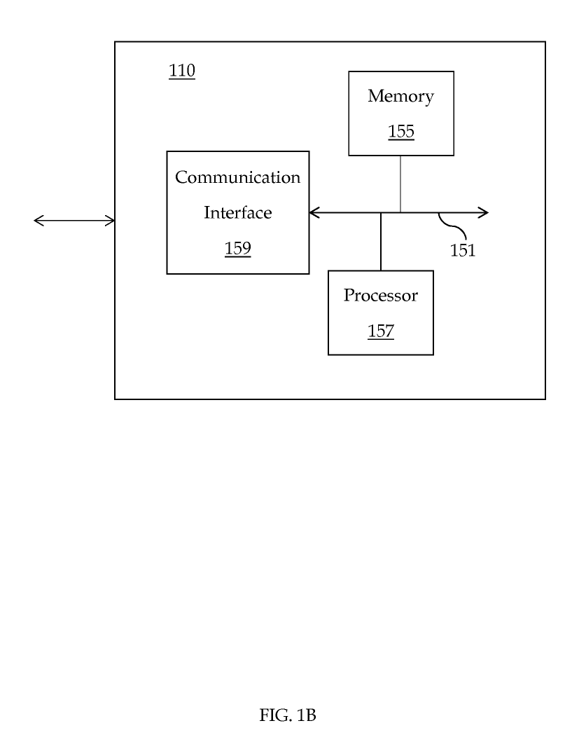

FIG. 1A shows an illustrative embodiment of the present invention. A contact center 100 comprises a server 110, a set of data stores or databases 114, such as, a subscribed database, or a customer database, containing contact or customer related information, resource related information, communication sessions related information, and other information that may enhance the value and efficiency of the contact processing, and a plurality of servers, namely a voice mail server 118, an Interactive Voice Response unit (e.g., IVR) 122, and other servers 126, a switch 130, a plurality of working resources operating packet-switched (first) communication devices 134-1-N (such as computer work stations, or personal computers), and/or circuit-switched (second) communication devices 138-1-M, all interconnected by a Local Area Network (LAN) 142, (or Wide Area Network (WAN)). In another embodiment of the present invention, the customer and resource related information may be replicated over multiple repositories.

The servers may be connected via optional communication lines 146 to switch 130. As will be appreciated, the other servers 126 may also include a scanner (which is normally not connected to switch 130 or Web Server), VoIP software, video call software, voice messaging software, an IP voice server, a fax server, a web server, an email server, and the like. Switch 130 is connected via a plurality of trunks to a circuit-switched network 150 (e.g., Public Switch Telephone Network (PSTN)) and via link(s) 154 to second communication devices 138-1-M. A security gateway 158 is positioned between server 110 and a packet-switched network 162 to process communications passing between server 110 and packet-switched network 162. In an embodiment of the present invention, security gateway 158 (as shown in FIG. 1A) may be Avaya Inc.'s, G700 Media Gateway™ and may be implemented as hardware such as via an adjunct processor (as shown) or as a chip in server 110.

Switch 130 and/or server 110 may be any architecture to direct incoming contacts to one or more communication devices associated with the resources of contact center 100. In some embodiments of the present invention, switch 130 may perform load-balancing functions by allocating incoming or outgoing contacts among a plurality of logically and/or geographically distinct contact centers. Illustratively, switch 130 and/or server 110 may be a modified form of the subscriber-premises equipment sold by Avaya Inc. under the names Definity™ Private-Branch Exchange (PBX) based ACD system, MultiVantage™ PBX, Communication Manager™, S8300™ media server and any other media servers, SIP Enabled Services™, Intelligent Presence Server™, and/or Avaya Interaction Center™, and any other products or solutions offered by Avaya, or another company. Typically, switch 130/server 110 is a stored-program-controlled system that conventionally includes interfaces to external communication links, a communications switching fabric, service circuits (e.g., tone generators, announcement circuits, etc.), memory to store control programs and data, and a processor (i.e., a computer) to execute the stored control programs to control the interfaces and the fabric and to provide ACD functionality. Other types of known switches and servers are well known in the art and therefore not described in detail herein.

First communication devices 134-1-N are packet-switched and may include, for example, IP hardphones such as the Avaya Inc.'s, 4600 Series IP Phones™, IP softphones such as Avaya Inc.'s, IP Softphone™, Personal Digital Assistants (PDAs), Personal Computers (PCs), laptops, packet-based H.320 video phones and conferencing units, packet-based voice messaging and response units, packet-based traditional computer telephony adjuncts, peer-to-peer based communication devices, and any other communication device.

Second communication devices 138-1-M are circuit-switched devices. Each of second communication devices 138-1-M corresponds to one of a set of internal extensions Ext-1-M, respectively. Second communication devices 138-1-M may include, for example, wired and wireless telephones, PDAs, H.320 videophones and conferencing units, voice messaging and response units, traditional computer telephony adjuncts, and any other communication devices.

It should be noted that embodiments of the present invention do not require any particular type of information transport medium between switch, or server and first and second communication devices, i.e., embodiments of the present invention may be implemented with any desired type of transport medium as well as combinations of different types of transport channels.

Packet-switched network 162 may be any data and/or distributed processing network, such as the Internet. Packet-switched network 162 typically includes proxies (not shown), registrars (not shown), and routers (not shown) to manage packet flows.

Packet-switched network 162 as shown in FIG. 1A is in communication with a first communication device 166 via a security gateway 170, and circuit-switched network 150 with an external second communication device 174.

In one configuration, server 110, packet-switched network 162, and first communication devices 134-1-N are Session Initiation Protocol (SIP) compatible and may include interfaces for various other protocols such as the Lightweight Directory Access Protocol (LDAP), H.248, H.323, Simple Mail Transfer Protocol (SMTP), IMAP4, ISDN, E1/T1, and analog line or trunk.

It should be emphasized the configuration of switch 130, server 110, customer communication devices, and other elements as shown in FIG. 1A is for purposes of illustration only and should not be construed as limiting embodiments of the present invention to any particular arrangement of elements.

Further, server 110 is notified via LAN 142 of an incoming contact or work item by the communications component (e.g., switch 130, a fax server, an email server, a web server, and/or other servers) receiving the incoming contact as shown in FIG. 1A. The incoming contact is held by the receiving telecommunications component until server 110 forwards instructions to the component to forward or route the contact to a specific contact center resource, such as IVR unit 122, voice mail server 118, and/or first or second telecommunication device 134-1-N, 138-1-M associated with a selected resource.

FIG. 1B illustrates at a relatively high-level hardware abstraction of a block diagram of a server such as server 110, in accordance with an embodiment of the present invention. Server 110 may include an internal communication interface 151 that interconnects a processor 157, a memory 155 and a communication interface circuit 159. Communication interface circuit 159 may include a receiver and transmitter (not shown) to communicate with other elements of contact center 100 such as switch 130, security gateway 158, LAN 142, and so forth. By use of programming code and data stored in memory 155, processor 157 may be programmed to carry out various functions of server 110.

Although embodiments are discussed with reference to client-server architecture, it is to be understood the principles of embodiments of the present invention may apply to other network architectures. For example, embodiments of the present invention may apply to peer-to-peer networks, such as those envisioned by the Session Initiation Protocol (SIP). In the client-server model or paradigm, network services and the programs used by end customers to access the services are described. The client side provides a customer with an interface to request services from the network, and the server side is responsible to accept customer requests for services and providing the services transparent to the customer. By contrast in the peer-to-peer model or paradigm, each networked host runs both the client and server parts of an application program. Additionally, embodiments of the present invention do not require the presence of packet- or circuit-switched networks.

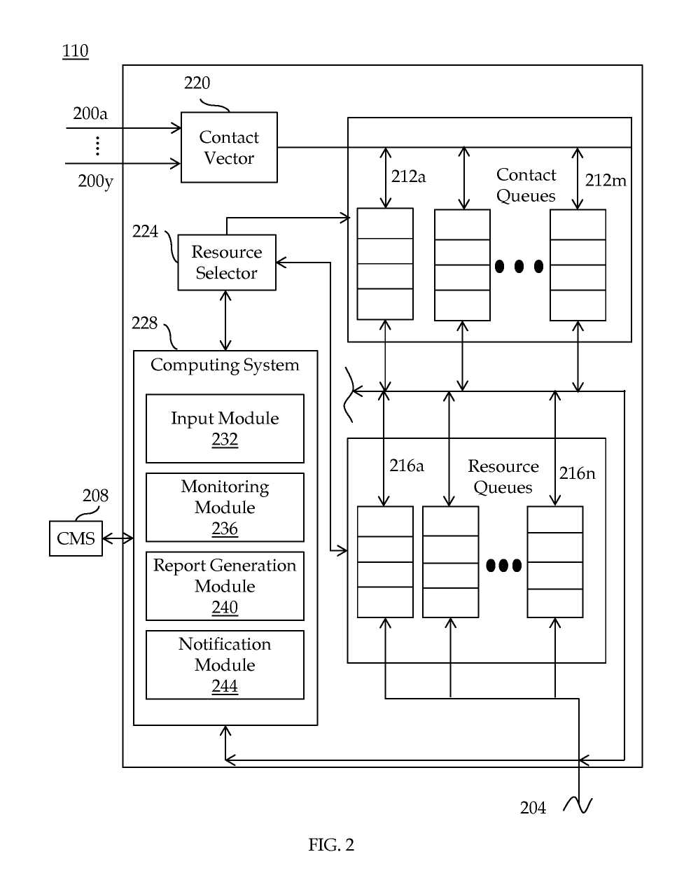

Referring to FIG. 2, one possible configuration of server 110 is depicted at a relatively high level of functional abstraction, according to an embodiment of the present invention. Server 110 is in communication with a plurality of contact or customer communication lines 200a-y (which may be one or more trunks, phone lines, etc.) and a resource communication line 204 (which may be a voice-and-data transmission line such as LAN 142 and/or a circuit switched voice line). Server 110 may include, but not restricted to, Avaya Inc.'s Operational Analyst™ (OA) with On-Line Analytical Processing (OLAP) technology, or a Call Management System (CMS) 208 that gathers contact records. OA and CMS will hereinafter be referred to jointly as CMS 208.

As shown in FIG. 2, among the data stored in server 110 is a set of contact queues 212a-m and a separate set of resource queues 216a-n. Each contact queue 212a-m corresponds to a different set of resource queues, as does each resource queue 216a-n. Conventionally, contacts are prioritized and either are queued in individual ones of contact queues 212a-m in their order of priority or are queued in different ones of a plurality of contact queues 212a-m that correspond to a different priority. Likewise, each resource's queues are prioritized according to his or her level of expertise or skill in that queue, and resources are queued in either individual ones of resource queues 216a-n in their order of expertise level, or in different ones of a plurality of resource queues 216a-n that correspond to a queue and each one of which corresponds to a different expertise level.

According to an embodiment of the present invention, included among the control programs in server 110 is a contact vector 220. Contacts or communication sessions incoming to contact center 100 are assigned by contact vector 220 to different contact queues 212a-m based upon a number of predetermined criteria, including a customer's identity, customer needs, contact center needs, current contact center queue lengths, a customer value, and an agent skill that is required for proper handling of the contact. Resources available to handle work items are assigned to resource queues 216a-n based upon the skills that they possess. A resource may have multiple skills, and hence may be assigned to multiple resource queues 216a-n simultaneously. Furthermore, a resource may have different levels of skill expertise (e.g., skill levels 1-N in one configuration or merely primary skill levels and secondary skill levels in another configuration), and hence may be assigned to different resource queues 216a-n at different expertise levels.

In one configuration, contact center 100 is operated by a contract operator (e.g., a supervisor, or a manager of contact center 100), and each of contact queues 212a-m, and possibly each of resource queues 216a-n, corresponds to a different client, such as but not limited to, a customer. Each client may have a separate Service Level Agreement (‘SLA’) or other type of performance measurement agreement with the contract operator regarding performance expectations, goals, requirements or specifications for the contact's respective queue(s).

Further, embodiments in accordance with the present invention may include, among the programs executing on server 110, a resource selector 224 and a computing system 228. Resource selector 224 and computing system 228 are stored either in a main memory, or in a peripheral memory (e.g., disk, CD ROM, etc.) or some other computer-readable medium of contact center 100. Further, resource selector 224 monitors the occupants of the contact and resource queues 212a-m and 216a-n, respectively, and contact center objectives, rules, and policies and select resources to service contacts.

Resource selector 224 distributes and connects these contacts to communication devices of available resources based on the predetermined criteria noted above. When resource selector 224 forwards a contact (or first communication session) to a resource, resource selector 224 also forwards customer-related information from database 114 to the resource's desktop or computer work station to preview and/or view (such as by a pop-up display) to enable the resource to provide better services to the customer. Depending on the contact center configuration, resource selector 224 may reallocate the contact to the resources of contact center 100. The resources process the contacts or communication sessions sent to them by resource selector 224.

In an embodiment of the present invention, the resources and their associated data are maintained and updated in database 114 of contact center 100. Upon the completion of handling a contact, a generator (not shown) collects selected metrics for the contact. These metrics may include skills involved in servicing the contact, an identifier of a servicing resource, contact duration, a transaction or contact type (e.g., sale, information request, complaint, etc.), time-of-day, result of the contact (e.g., type of sale, number of units sold, an average revenue generated, etc.), and so forth. The metrics along with other statistics is typically gathered by CMS 208.

According to an embodiment of the present invention, computing system 228 includes certain modules, such as, but not restricted to, an input module 232, a monitoring module 236, a report generation module 240, and a notification module 244. In some embodiments, one or more of input module 232, monitoring module 236, report generation module 240, and notification module 244 may be implemented by one or more software processes running on server 110. Server 110 may implement one or more software processes by use of processor 157 being suitably programmed by use of software instructions stored in memory 155 coupled to processor 157.

Input module 232 may receive a subscription request from a resource, according to an embodiment of the present invention. In an embodiment of the present invention, a subscription request may be received from a resource who has subscribed to an application to receive information associated with activities of contact center 100 when the resource is not available for a specific period of time. In one embodiment, the resource may be unavailable within the premises of contact center 100 due to, but not restricted to, health issues, meetings, vacations, and the like. In another embodiment, the resource may be present within the premises of contact center 100 but may not be available to manage a communication session due to, but not restricted to, intra-enterprise meetings, training sessions, a lunch break, and the like. The subscription request may be received from the resources in one of a variety of message types, such as a Short Messaging Service (SMS) text message, an email, an audio message, a video message, a web chat, an internal portal of contact center 100, and the like.

In an embodiment of the present invention, the subscription request may include subscription criteria. In one embodiment of the present invention, the subscription criteria may be a customer information, such as, but not restricted to, a name, an identification number, a phone number, an email, a type of priority, and the like. The type of priority of a customer may be, but not restricted to, a high priority customer, a medium priority customer, or a low priority customer. A customer having higher revenue products and/or services provided by contact center 100 may be referred to as a high priority customer. A customer having medium revenue products and/or services provided by contact center 100 may be referred to as a medium priority customer. Further, a customer having low revenue products and/or services provided by contact center 100, or a potential customer of contact center 100 may be referred to as a low priority. For example, subscription criteria of a resource indicate that the resource is interested in only potential customers.

The subscription criteria may include a keyword in which the resource may be interested in, in an embodiment of the present invention. In an exemplary scenario, for a resource may be interested in financial investments, then the words or phrases “financial”, “financial investment”, “investment” and so forth may be used as keywords.

In another embodiment of the present invention, the subscription criteria may include, but not restricted to, time and/or duration at which the resource may be unavailable to manage communication sessions. For example, a resource “A” may be on vacation for five days and therefore is not available within the contact center to provide services to customers. In another embodiment of the present invention, the subscription criteria may include, but not restricted to, context of communication session in which the resource may be interest. For example, resource “A” may be interested in communication sessions associated with financial investment in mutual funds. In another embodiment of the present invention, the subscription criteria may include, but not restricted to, type of communication session associated with a customer in which the resource may be interested The type of communication session may include, but not restricted to, a voice session, a video session, a Short Message Service (SMS) text message, a web chat session, an Instant Messaging (IM) session, an email communication session, an Interactive Voice Response (IVR) session, a Voice over Internet Protocol (VoIP) session, and so forth. For example, resource “B” may be interested in all voice communication sessions.

In another embodiment, the subscription criteria may be, but not restricted to, time at which the resource may desire to receive a notification about activities of/within contact center 100. In an exemplary scenario, the resource may desire to receive a notification about an activity of contact center 100 on, but not restricted to, weekends, overnights, end of day, scheduled absence from contact center 100, and the like. In one embodiment of the present invention, the subscription criteria may be, but not restricted to, type of notification to be received by the resource. The type of notification may be sent in one of a variety of message types, such as a voice notification, a video notification, a Short Message Service (SMS) text message, a web chat notification, an Instant Messaging (IM) notification, an email notification, a Voice over Internet Protocol (VoIP) notification, and so forth. For example, the resource “X” may desire to receive an email associated with activities of contact center 100.

In one embodiment of the present invention, the subscription criteria may include, but not restricted to, a real time notification, a historical notification, or a combination thereof. A historical notification may include, but not restricted to, notifications of previous communication sessions. In one embodiment, the historical notification may include, but not restricted to, no activity notification, i.e., there is no activity within contact center 100, in which a resource “X” may be interested. A real time notification may include, but not restricted to, real time activities of contact center 100.

Embodiments of input module 232 may generate a profile of the resource based on the received subscription request. The profile of the resource may include, but not restricted to, a name, a designation, a phone number, an extension number, resource identification (ID), social networking usernames, subscription criteria, likes, dislikes, hobbies, work history, education history, age, performance, cultural background, skill set, technical training or experience in supporting a particular industry, company, or customer, and so forth. As used herein, the term “skill set” refers to a set of resource data that may be used by contact center 100 to characterize a resource. Such resource data may include, but not restricted to, biographical resource data, demographic resource data, external or internal behavioral resource data, and the like. The behavioral data may include the resource's history with respect to contact center 100 and/or any other entity or social media channel. However, resource data is not limited in this regard and may include any other type of resource data used by contact center 100 to characterize or classify the resources of contact center 100.

Further, the profile of the resource may include any other resource data collected from one or more sources external to contact center 100. Additionally, the profile having the details of the resource may be raw resource data or processed resource data. That is, the resource data may be analyzed to characterize the resource and thereafter may be used to provide customized or personalized services to the customer. For example, a resource profile may be a set of values associated with a resource and a set of characteristics, where the values may be selected based on the resource data obtained. However, the present application is not limited in this regard and any other methods to evaluate resource data to provide services may be used without limitation. In another embodiment of the present invention, input module 232 may further update the profile of the resource based on the received subscription request.

Embodiments of monitoring module 236 may monitor parameters associated with communication sessions. Monitoring module 236 may monitor parameters associated with communication sessions based on the subscription criteria. Monitoring module 236 may monitors a type of the communication session between a resource and a customer. The type of the communication session may include, but not restricted to, a voice session, a video session, a Short Message Service (SMS) text message, a web chat session, an Instant Messaging (IM) session, an email communication session, an Interactive Voice Response (IVR) session, a Voice over Internet Protocol (VoIP) session, and so forth. In an exemplary scenario, if the resource is interested in voice communication sessions, then only voice communication sessions are monitored. In another exemplary scenario, monitoring module 236 may monitor video communication sessions and web chats if the subscription criteria indicate that the resource is interested in video and web chat communication sessions. In an embodiment of the present invention, the communication session may be initiated by a customer of contact center 100. In another embodiment of the present invention, the communication session may be initiated by a resource of contact center 100.

Embodiments of monitoring module 236 may monitor details of the monitored communication session. Monitoring module 236 may monitor details of the communication session to determine context of the communication session by monitoring inputs selected by the customer in an IVR menu of contact center 100. The context of the communication session may include, but not restricted to, a product inquiry support, a sales support, a health, or car policy support, a financial transaction support, and so forth. In an exemplary scenario, a customer may provide inputs in an IVR menu of contact center 100 for an “accidental insurance policy”, then it may be determined that context of the communication session is a product inquiry support for insurance, and more particularly for an accidental insurance policy.

Embodiments of monitoring module 236 may further monitor customer information associated with the communication session. The customer information may include, but not restricted to, personal data (for example, a name, a social networking username, etc.), contact data (for example, a telephone number, an email address, etc.), educational background, business contacts, education and work histories, likes, hobbies, favorite sport teams, frequency of conversations with a resource, a history of queries, a customer identification, communication history with contact center 100, and so forth. Monitoring module 236 may extracts the customer information from various social networking websites.

Furthermore, monitoring module 236 may monitors a type of priority of the customer, according to an embodiment of the present invention. In an exemplary scenario, a customer may be, but not restricted to, a high priority customer, a medium priority customer, a low priority customer. In an exemplary scenario, monitoring module 236 may monitors activities associated with high priority customers as the subscription criteria indicate that a resource is interested in activities associated with only high priority customers.

Furthermore, monitoring module 236 may extracts keywords from the monitored communication session, according to an embodiment of the present invention. In an exemplary scenario, a customer may inquire about “accidental insurance policy inquiry” then “accidental insurance”, “policy”, and “inquiry” are extracted as keywords from the monitored communication session. Monitoring module 236 may determine keywords from a variety of session types, such as a voice communication session, a video session, a web chat, an email, an SMS text message, and the like, in another embodiment of the present invention.

Embodiments of monitoring module 236 may monitor the parameters associated with the communication session in a real-time environment. In another embodiment, monitoring module 236 may monitor the parameters at regular intervals. In another embodiment, monitoring module 236 may monitor the parameters continuously.

Embodiments of monitoring module 236 may determine availability of the resource. Monitoring module 236 may automatically determine whether or not the resource is available within contact center 100, based on no activity state, or an idle state of the resource. Monitoring module 236 may determine whether or not the resource is available within contact center 100, based on a manual input provided by the resource. The resource may indicate that the resource is going to take a break by pressing a button, by changing its “online” status to “not on desk” status, or “away” status, and the like.

Embodiments of monitoring module 236 may monitor routing mechanism of communication sessions to a particular resource. For example, the subscription criteria indicate that the resource is interested in communication sessions managed by a resource “A”.

Further, embodiments of monitoring module 236 may analyze the monitored parameters to generate data metrics. Monitoring module 236 may analyze the monitored parameters to generate data metrics based on the received subscription request. The data metrics may include, but not restricted to, parameters of communication sessions monitored based on the received subscription request.

However, embodiments of the present application are not limited in this regard and may include other parameters associated with the communication session that may be used without limitation.

Embodiments of report generation module 240 may analyze the data metrics to generate a subscription report based on monitored parameters that are of interest to the resource. The subscription report may be based upon, for example: a summary of activities of contact center 100; data in which a resource may be interested in; activity of a customer; the record of the resource contacting contact center 100; context of communication sessions; network links associated with data such as, video recordings, text documents, and the like. Report generation module 240 may generate more than one subscription reports, in another embodiment of the present invention.

Embodiments of report generation module 240 may generate the subscription report at a scheduled time defined by the resource in the subscription request, e.g., at the end of a day. The subscription report may include, but not restricted to, historical data associated with communication sessions of contact center 100. In another exemplary scenario, a subscription report may be generated after two hours as the scheduled arrival time of a resource in contact center 100 is defined. In another embodiment of the present invention, report generation module 240 may generate a subscription report having real time data when a specific event is detected. In an exemplary scenario, if an outcome of a communication session deteriorates, then a subscription report of this deterioration is generated. In another exemplary scenario, an ongoing communication session is monitored and if a particular keyword such as, “issue in mobile phone” is detected then a subscription report having data associated with the communication session is reported to the resource.

Embodiments of notification module 244 may generate notifications for the resource. The notifications may be generated based on generated subscription reports. The notification may include, but not restricted to, number of communication sessions, number of emails responded, number of web chat sessions received, network links to transcripts, and/or recordings to review by the resource, and the like. Notification module 244 may generate real time notifications that include real time data. Notification module 244 may generate historical notifications that include historical data.

Embodiments of notification module 244 may present the notification to the resource. The notification may be presented to the resource at a time specified by the resource in the subscription request. For example, a notification having historical data may be presented to the resource at 5 PM, prior to the resource's arrival in contact center 100. Notification module 244 may present the notification in one of a variety of message types, such as an SMS text message, a web chat, an Instant Messaging (IM), an audio notification, a video notification, an email, and the like. Further, notification module 244 may customize the generated notification based on characteristics of a resource device, resource profile, or a combination thereof.

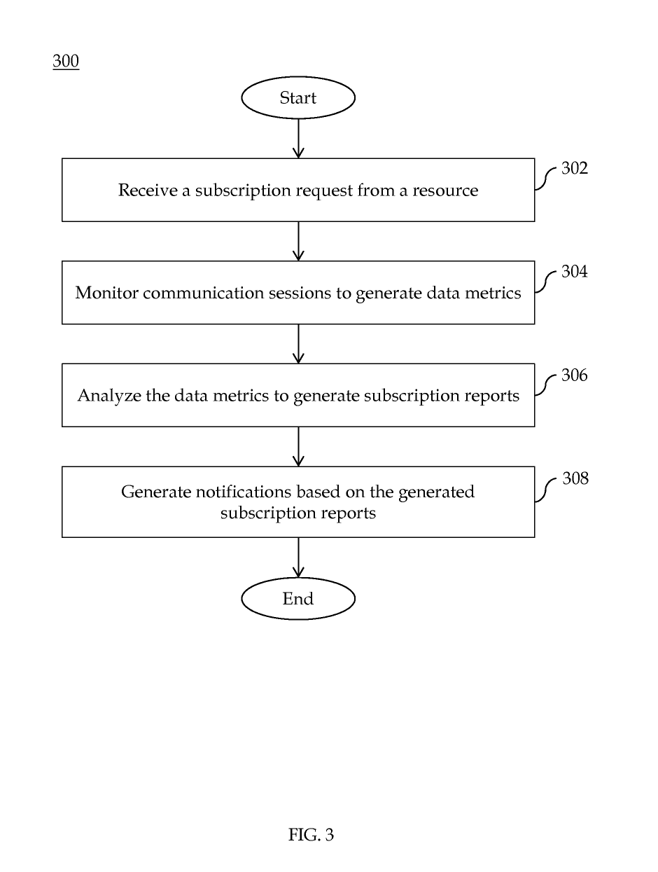

FIG. 3 depicts a flowchart of a method 300 to manage communication sessions in contact center 100, according to an embodiment of the present invention.

At step 302, embodiments of computing system 228 receive a subscription request from a resource. A subscription request may be received from a resource who has subscribed to an application to receive information associated with activities of contact center 100 when the resource is not available for a specific period of time. In one embodiment, the resource may be unavailable within the premises of the contact center 100. In another embodiment, the resource may be available within the premises of contact center 100 but may not be available to manage a communication session. In an embodiment of the present invention, the subscription request may include subscription criteria. As discussed, the subscription criteria may be a customer information, keywords, time and/or duration at which the resource may be unavailable to manage communication sessions, context of communication session, type of communication session, time at which the resource may desire to receive a notification, and the like. In an exemplary scenario, a resource “A” may be interested in receiving summary of activities such as, email communication sessions, of a high priority customer “X”.

At step 304, embodiments of computing system 228 monitor a communication session between a customer and a resource based on the subscription request. In the above exemplary scenario, computing system 228 monitors email communication sessions associated with the customer “X”. Computing system 228 further monitors customer information associated with the communication session. The customer information may include, but not restricted to, personal data, contact data, educational background, business contacts, education and work histories, likes, and so forth. Furthermore, computing system 228 monitors only high priority customers. Computing system 228 further determines context of the communication session. In the above exemplary scenario, the customer “X” may desire to inquire about new life insurance policies. Furthermore, computing system 228 extracts keywords from the monitored communication session. Computing system 228 generates data metrics based on the received subscription request. The data metrics may include, but not restricted to, parameters of the monitored communication sessions.

At step 306, embodiments of computing system 228 analyze the data metrics. Computing system 228 may analyze the data metrics to generate a subscription report. The subscription report may be, but not restricted to, a summary of activities of contact center 100 that may be of interest to the resource. The subscription report may include, but not restricted to, data in which a resource may be interested. In the above exemplary scenario, the subscription report may include, but not restricted to, inquiry about new life insurance policy, five communication sessions, text document of emails, and the like.

Next, at step 308, embodiments of computing system 228 generate notifications for the resource. The notifications may be generated based on generated subscription reports. The notification may include, but not restricted to, number of communication sessions, number of emails responded, number of web chat sessions received, network links to transcripts, and/or recordings to review by the resource, and the like. Computing system 228 generates real time notifications that may include real time data, and/or historical notifications that may include historical data. Further, computing system 228 presents the notification to the resource. The notification may be presented to the resource at a time specified by the resource in the subscription request.

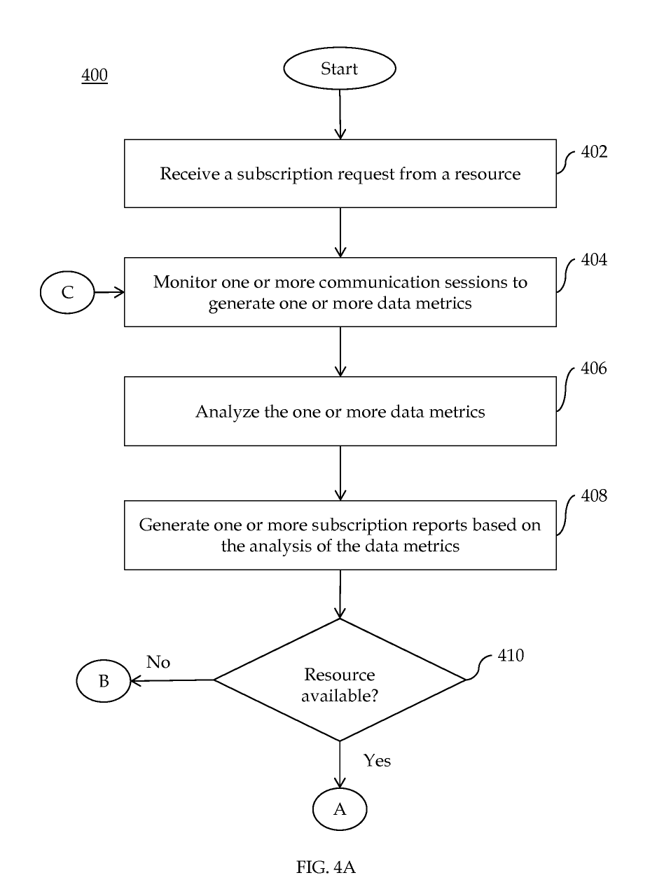

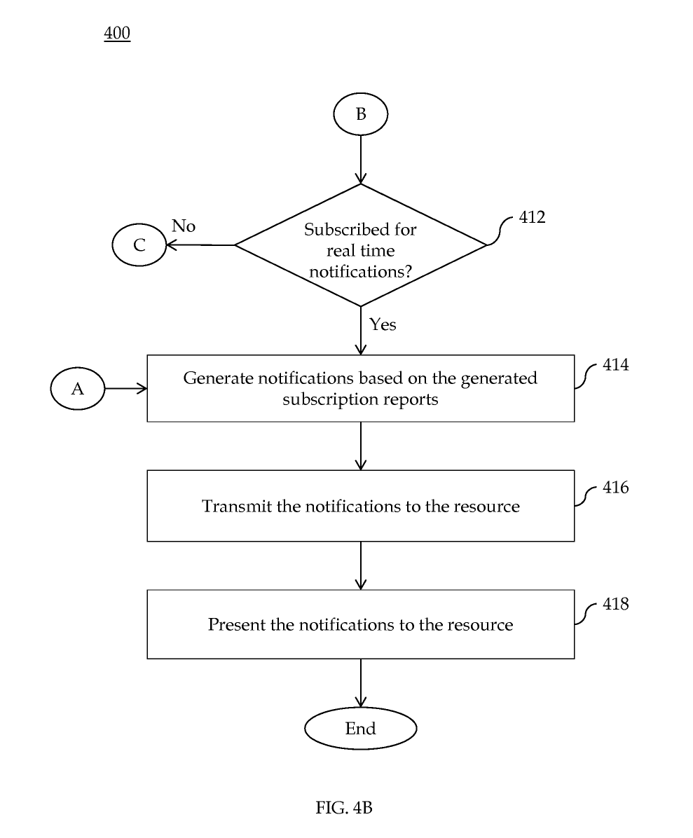

FIGS. 4A and 4B depict a flowchart of a method 400 to manage one or more communication session in contact center 100, according to another embodiment of the present invention.

At step 402, embodiments of computing system 228 receive a subscription request from a resource. A subscription request may be received from a resource who has subscribed to an application to receive information associated with activities of contact center 100 when the resource is not available for a specific period of time. For example, the resource may be unavailable within the premises of contact center 100. In another example, the resource may be available within the premises of contact center 100 but may not be available to manage a communication session. The subscription request may include subscription criteria. As noted previously, the subscription criteria may be a customer information, keywords, time and/or duration at which the resource may be unavailable to manage communication sessions, context of communication session, type of communication session, time at which the resource may desire to receive a notification, and the like. In an exemplary scenario, a resource “A” register an interest in abandoned communication sessions, or communication sessions that have not been managed by a resource in contact center 100 for a specific time period, e.g., for at least five minutes.

At step 404, embodiments of computing system 228 monitor communication sessions based on the subscription request. In the above exemplary scenario, computing system 228 monitors all the communication sessions that are not managed by a resource of contact center 100. Computing system 228 further monitors customer information associated with abandoned communication session. The customer information may include, but not restricted to, personal data, contact data, work histories, and so forth. Furthermore, computing system 228 monitors a type of priority of the customers associated with the abandoned communication sessions. Computing system 228 further determines context of the abandoned communication sessions based on inputs selected by a customer in an IVR menu of contact center 100, e.g., if a high priority customer “X” desires to inquire about a smart phone, and a low priority customer “Y” desires to lodge a complaint due to an issue in broadband service. Computing system 228 generates data metrics based on the received subscription request. The data metrics may include, but not restricted to, type of priority of customers, context of communication session, number of times a customer calls contact center 100, and the like.

Further, at step 406, embodiments of computing system 228 analyze the data metrics. At step 408, computing system 228 generates a subscription report. The subscription report may be, but not restricted to, a summary of activities associated with the abandoned communication sessions within contact center 100. The subscription report may include, but not restricted to, reasons why the communication sessions were abandoned, what is the percentage of distribution of the abandoned communication sessions during a specific period, why the communication sessions were outsourced, working status of other resources, and the like.

At step 410, computing system 228 determines whether or not the resource is available. If the resource is not available to manage the communication sessions, then method 400 proceeds to step 412. Otherwise, method 400 proceeds to step 414.

At step 412, computing system 228 determines whether or not the resource subscribed to is configured to receive real time notifications. If the answer if affirmative (i.e., the resource is subscribed to for real time notifications), then process 400 proceeds to step 414. Otherwise, method 400 returns to step 404 and continues monitoring communication sessions.

Next, at step 414, embodiments of computing system 228 generates notifications for the resource. The notifications may be generated based on the generated subscription reports. The notification may include, but not restricted to, number of abandoned communication sessions, type of priority of customers associated with abandoned communication sessions, context of abandoned communication sessions, and the like. Embodiments of computing system 228 generate real time notifications that may include real time data. In the above exemplary scenario, a real time notification is generated for the high priority customer “X” who inquires about a smart phone. In another exemplary scenario, a historical notification may be generated for a low priority customer “Y” who lodges a complaint due to technical troubles in their broadband service.

Thereafter, at step 416, embodiments of computing system 228 transmit the notifications to the resource. Computing system 228 transmits the notifications to the resource through a communication network, such as network 162 and/or network 150.

Further, at step 418, embodiments of computing system 228 present the notification to the resource. The notification may be presented to the resource at a time specified by the resource in the subscription request. Computing system 228 may present the notification in one of a variety of message types, such as one of an SMS text message, a web chat, an Instant Messaging (IM), an audio notification, a video notification, an email, and the like, based on the subscription criteria, in an embodiment of the present invention.

The exemplary embodiments of this present invention have been described in relation to a contact center. However, to avoid unnecessarily obscuring the present invention, the preceding description omits a number of known structures and devices. This omission is not to be construed as a limitation of the scope of the present invention. Specific details are set forth by use of the embodiments to provide an understanding of the present invention. It should however be appreciated that the present invention may be practiced in a variety of ways beyond the specific embodiments set forth herein.

Furthermore, while the exemplary embodiments of the present invention illustrated herein show the various components of the system collocated, certain components of the system can be located remotely, at distant portions of a distributed network, such as a LAN and/or the Internet, or within a dedicated system. Thus, it should be appreciated, that the components of the system can be combined in to one or more devices, such as a switch, server, and/or adjunct, or collocated on a particular node of a distributed network, such as an analog and/or digital telecommunications network, a packet-switch network, or a circuit-switched network.

It will be appreciated from the preceding description, and for reasons of computation efficiency, the components of the system can be arranged at any location within a distributed network of components without affecting the operation of the system. For example, the various components can be located in a switch such as a PBX and media server, gateway, in one or more communications devices, at one or more users' premises, or some combination thereof. Similarly, one or more functional portions of the system could be distributed between a telecommunications device(s) and an associated computing device.

Furthermore, it should be appreciated the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire and fiber optics, and may take the form of acoustic or light waves, such as those generated during radio-wave and infra-red data communications.

Also, while the flowcharts have been discussed and illustrated in relation to a particular sequence of events, changes, additions, and omissions to this sequence can occur without materially affecting the operation of embodiments of the present invention.

A number of variations and modifications of the present invention can be used. It would be possible to provide for some features of the present invention without providing others.

For example, in one alternative embodiment of the present invention, the systems and methods of this present invention may be implemented with a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device or gate array such as PLD, PLA, FPGA, PAL, special purpose computer, any comparable means, or the like.

In general, any device(s) or means capable of implementing the methodology illustrated herein can be used to implement the various aspects of this present invention. Exemplary hardware that can be used for the present invention includes computers, handheld devices, telephones (e.g., cellular, Internet enabled, digital, analog, hybrids, and others), and other hardware known in the art. Some of these devices include processors (e.g., a single or multiple microprocessors), memory, non-volatile storage, input devices, and output devices. Furthermore, alternative software implementations including, but not limited to, distributed processing or component/object distributed processing, parallel processing, or virtual machine processing can also be constructed to implement the methods described herein.

In yet another embodiment of the present invention, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with embodiments of the present invention is dependent on the speed and/or efficiency requirements of the system, the particular function, and the particular software or hardware systems or microprocessor or microcomputer systems being utilized.

In yet another embodiment of the present invention, the disclosed methods may be partially implemented in software that can be stored on a storage medium, executed on programmed general-purpose computer with the cooperation of a controller and memory, a special purpose computer, a microprocessor, or the like. In these instances, the systems and methods of this present invention can be implemented as program embedded on personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

Although the present invention describes components and functions implemented in the embodiments with reference to particular standards and protocols, it is not limited to such standards and protocols. Other similar standards and protocols not mentioned herein are in existence and considered to be included in the present invention. Moreover, the standards and protocols mentioned herein and other similar standards and protocols not mentioned herein are periodically superseded by faster or more effective equivalents having essentially the same functions. Such replacement standards and protocols having the same functions are considered equivalents included in the present invention.

The present invention, in various embodiments, configurations, and aspects, includes components, methods, processes, systems and/or apparatus substantially as depicted and described herein, including various embodiments, sub-combinations, and subsets thereof. Those of skill in the art will understand how to make and use the present invention after understanding the present disclosure. The present invention, in various embodiments, configurations, and aspects, includes providing devices and processes in the absence of items not depicted and/or described herein or in various embodiments, configurations, or aspects hereof, including in the absence of such items as may have been used in previous devices or processes, e.g., to improve performance, achieving ease and/or reducing cost of implementation.

The foregoing discussion of the present invention has been presented for purposes of illustration and description. It is not intended to limit the present invention to the form or forms disclosed herein. In the foregoing Detailed Description, for example, various features of the present invention are grouped together in one or more embodiments, configurations, or aspects for the purpose of streamlining the disclosure. The features of the embodiments, configurations, or aspects may be combined in alternate embodiments, configurations, or aspects other than those discussed above. This method of disclosure is not to be interpreted as reflecting an intention the present invention requires more features than are expressly recited in each claim. Rather, as the following claims reflect, inventive aspects lie in less than all features of a single foregoing disclosed embodiment, configuration, or aspect. Thus, the following claims are hereby incorporated into this Detailed Description, with each claim standing on its own as a separate embodiment of the present invention.

Moreover, though the description of the present invention has included description of one or more embodiments, configurations, or aspects and certain variations and modifications, other variations, combinations, and modifications are within the scope of the present invention, e.g., as may be within the skill and knowledge of those in the art, after understanding the present disclosure. It is intended to obtain rights that include alternative embodiments, configurations, or aspects to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

What is claimed is:

1. A computing system to manage a communication session in an enterprise, the system comprising:
an input module to receive a subscription request from a resource, wherein the subscription request comprises a subscription criteria;
a monitoring module to monitor the communication session to generate a data metric based on the subscription criteria;
a report generation module to analyze the generated data metrics to generate a subscription report; and
a notification module to generate a notification based on the generated subscription reports.

2. The system of claim 1, wherein the input module is configured to generate a profile of the resource based on the subscription criteria.

3. The system of claim 1, wherein the input module is configured to store the subscription criteria in a subscribed database.

4. The system of claim 1, wherein the monitoring module is configured to store the data metric in a customer database.

5. The system of claim 1, wherein the generated subscription report comprises historical data.

6. The system of claim 1, wherein the generated subscription report comprise real time data.

7. The system of claim 1, wherein the monitoring module is configured to determine availability of the resource.

8. The system of claim 1, wherein the notification includes one of a text message, an email, an audio call, a video call, a network link, a web chat, or a combination thereof.

9. A computer-implemented method to manage a communication session, the method comprising:
receiving a subscription request from a resource, wherein the subscription request comprises a subscription criteria;
monitoring the communication session to generate a data metric based on the subscription criteria;
analyzing the generated data metric to generate subscription reports; and
generating notifications based on the generated subscription reports.

10. The method of claim 9, further comprising the step of: generating a profile of the resource based on the subscription criteria.

11. The method of claim 9, further comprising the step of: storing the subscription criteria in a subscribed database.

12. The method of claim 9, further comprising the step of: storing the data metric in a customer database.

13. The method of claim 9, wherein the generated subscription report comprises historical data.

14. The method of claim 9, wherein the generated subscription report comprise real time data.

15. The method of claim 9, further comprising the step of: determining availability of the resource.

16. A computer-implemented method to manage one or more communication sessions, the method comprising:
receiving a subscription request from a resource, wherein the subscription request comprises a subscription criteria;
storing the one or more subscription criteria in a subscribed database;
monitoring the one or more communication sessions to generate one or more data metrics based on the subscription criteria;
storing the one or more data metrics in a customer database;
analyzing the one or more generated data metrics to generate one or more subscription reports;
generating one or more notifications based on the one or more generated subscription reports.

17. The method of claim 16, further comprising the step of: generating one or more profiles of the resource based on the subscription criteria.

18. The method of claim 16, wherein the one or more generated subscription reports comprises historical data.

19. The method of claim 16, wherein the one or more generated subscription reports comprise real time data.

20. The method of claim 16, further comprising the step of: determining availability of the resource.
